(19) United States
(12) Patent Application Publication
(10) Pub. No.: US 2004/0016733 A1
(43) Pub. Date: Jan. 29, 2004

(54) Laser adjustment of head suspension or head gimbal assembly static attitude

(75) Inventor: Visit Thaveeprungsriporn, Ayutthaya (TH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: KR Precision Public Company Limited, Ayutthaya (TH)

(21) Appl. No.: 10/319,784

(22) Filed: Dec. 12, 2002

Related U.S. Application Data
(60) Provisional application No. 60/398,983, filed on Jul. 25, 2002.

(51) Int. Cl. B23K 26/00

(52) U.S. Cl. 219/121.85; 219/121.61

(57) ABSTRACT

A non-contact method for adjusting static attitude in suspension for use in a rigid disk drive is disclosed. The method includes the use of one or more lasers as a heat source directed at a well-defined region on either or both sides of the gimbal outrigger. Irradiation by the laser causes thermal gradient across the thickness of the outrigger and simultaneously changes its residual stress distribution, which alters the static attitude change in suspension or head gimbal assemblies. In this present invention, initial pitch and roll static attitude is measured by the measurement apparatus, this result is then used to calculates the laser parameter required for irradiation on either or both side of the outrigger to achieve the desired static attitude condition. An adjustment is accomplished with irradiation on either or both sides of the outrigger with one or more lasers while suspension or head gimbal assemblies are in free-state.

### CROSS-REFERENCES TO RELATED APPLICATIONS

The application claims priority of U.S. Provisional Application No. 60/398,983 filed Jul. 25, 2002, commonly owned, and in the name of Visit Thaveeprungsriporn, which is incorporated by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to memory storage devices. More particularly, the invention provides an apparatus and method for adjusting the static attitude of a head suspension assembly of a magnetic disc drive and more specifically to an apparatus and method utilizing laser irradiation directed on different specific region of the gimbal for such adjustment.

Head suspension assemblies have been commonly used in rigid magnetic disk drives to accurately position the read and write head in close proximity to the spinning storage medium. Such assemblies include a base plate, a load beam and a flexure (gimbal) to which a slider is to be mounted. The slider supports a read/write head and possess special aerodynamic shape, which allows read/write head to fly over the air bearing created by the spinning disk. The load beam is generally composed of an actuator mounting section, a spring and a rigid region. The spring region gives the suspension a spring force or preload counteracting the aerodynamic lift force created by the spinning medium during a reading/writing process. The gimbal is mounted at the distal end of the load beam and support the slider allowing this one to have pitch and roll movement in order to follow the irregularities of the disk surface.

A recording head suspension assembly has a head slider mounted on a gimbal area for reading/writing data. An important parameter during operation is to maintain the slider in close proximity of the rotating disk, regard less to the disk irregularities. This parameter is often referred as static attitude of the slider. As the storage density of magnetic disks increases, the flying height of actual disk drive is quickly decreasing and the pitch and roll static attitude of head gimbal assemblies become more important. Because of the natural residual stress in stainless steel as well as suspension assembly process, the pitch and roll static attitude must often be adjusted to a specific target with little variation providing a consistent flying height.

Several techniques are known for such adjustment. Examples of mechanical methods were disclosed in U.S. Pat. No. 6,366,430, which proposes to twist the load beam as a mean to adjust the pitch and roll angle as well as in U.S. application Ser. No. 09/938,321, which proposes to directly operate on the gimbal by clamping and bending the gimbal arms (or beams) with the help of a piezo micro actuator. Non-contact methods have also been disclosed. U.S. Pat. Nos. 5,682,780, 5,832,764, and 6,011,239 disclose methods where the load beam of the suspension is laser irradiated in order to modified either or both static attitude angle. Although many improvements have been made, numerous limitations still exist.

From the above, it is seen that an improved technique for operating a disk drive apparatus is desirable.

### SUMMARY OF THE INVENTION

According to the present invention, techniques for memory storage devices are provided. More particularly, the invention provides an apparatus and method for adjusting the static attitude of a head suspension assembly of a magnetic disc drive and more specifically to an apparatus and method utilizing laser irradiation directed on different specific region of the gimbal for such adjustment.

In a specific embodiment, the present invention provides a non-contact method for adjusting static attitude of suspension assemblies. The adjustment is based on laser irradiation of a specific area of the suspension. Preferably, a laser spot is applied on the suspension gimbal giving a more direct and accurate adjustment.

In an alternative specific embodiment, the invention provides a method for manufacturing a gimbal assembly for a disk drive apparatus. The method comprises irradiating a desired portion of a suspension material. The method maintains other portions of the suspension material free from irradiation. The method causes a bend to a predetermined angle in the suspension material in a vicinity of the desired portion of the suspension material based upon the irradiating of the desired portion.

In still an alternative embodiment, the invention provides a method for adjusting pitch and roll static attitude of suspension and/or head gimbal assembly. The method includes measuring a pitch and roll static attitude of suspension or head gimbal assemblies simultaneously. The method calculates or determines the laser energy desired on either or both sides of the outrigger to cause a desired adjustment of both pitch and roll static attitude simultaneously. The method also irradiates a single or multiple spot of continuous wave or pulsed laser on a well-defined location on either or both sides of the gimbal beam, outrigger, tip or tongue while suspension or head gimbal assemblies are in free-state.

Other and further features as well as advantages characterizing the invention will appear from the following detailed description and associated drawings.

### BRIEF DESCRIPTION OF THE DRAWINGS

FIG. 1 is a simplified isometric view of the suspension assembly l0 according to an embodiment of the present invention.

FIG. 2 is a simplified side view of the suspension assembly l0 according to an embodiment of the present invention.

FIG. 3 is a more detailed side view of the gimbal assembly according to an embodiment of the present invention.

FIG. 4 is a simplified top view of the gimbal assembly according to an embodiment of the present invention.

FIG. 5 is a simplified flow diagram of the full suspension manufacturing according to an embodiment of the present invention.

FIG. 6 is a simplified flow diagram of the pitch and roll adjustment machine 700 according to an embodiment of the present invention.

FIG. 7 illustrate a laser bending principle according to an embodiment of the present invention.

FIG. 8 illustrate a laser bending principle (after irradiation) according to an embodiment of the present invention.

FIG. 9 illustrate a static attitude adjustment process (before adjustment) according to an embodiment of the present invention.

FIG. 10 illustrate a static attitude adjustment process (irradiation) according to an embodiment of the present invention.

FIG. 11 illustrate a static attitude adjustment process (after adjustment) according to an embodiment of the present invention.

FIG. 12 shows a relation existing between the laser power and the bending angle according to an embodiment of the present invention.

FIG. 13 shows a relation existing between the scanning velocity and the bending angle according to an embodiment of the present invention.

### DETAILED DESCRIPTION OF THE INVENTION

According to the present invention, techniques for memory storage devices are provided. More particularly, the invention provides an apparatus and method for adjusting the static attitude of a head suspension assembly of a magnetic disc drive and more specifically to an apparatus and method utilizing laser irradiation directed on different specific region of the gimbal for such adjustment.

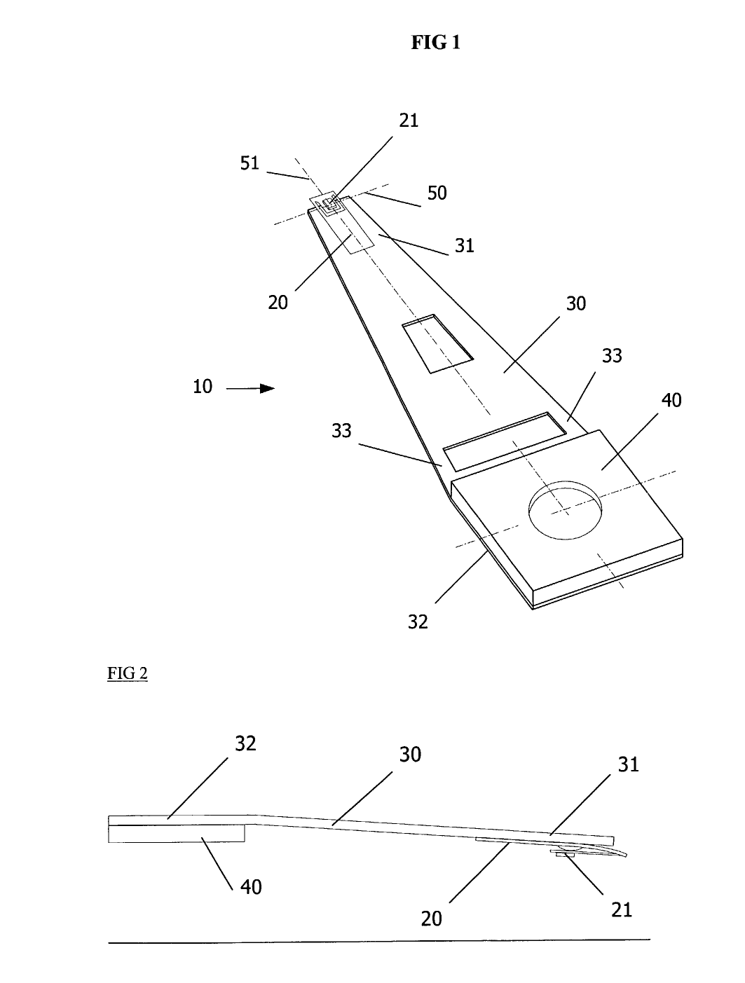

FIG. 1 is a simplified isometric view of the suspension assembly 10 according to an embodiment of the present invention. FIG. 2 is a simplified side view of the suspension assembly 10 according to an embodiment of the present invention. These diagrams are merely examples, which should not unduly limit the scope of the claims herein. One of ordinary skill in the art would recognize many other variations, modifications, and alternatives. As shown, FIGS. 1 and 2 illustrate a head suspension assembly (HSA) 10 formed with a gimbal 20, an air bearing slider 21 mounted on the gimbal 20, a load beam 30 and a base plate 40. The load beam 30 has a mounting region 32 on its proximal end and a flexure mounting region 31 on its distal end. The base plate 40 is typically welded on the mounting region 32 and ensures rigidity of the mounting. The load beam comprises also a spring region 33 between its proximal and distal region. The spring region 33 gives the suspension the ability to maintain, a precise distance between the head and the media to be read (fly height) by giving the beam a pre load force counteracting the air bearing crated by the spinning medium. Further details of the assembly are provided throughout the present specification and more particularly below.

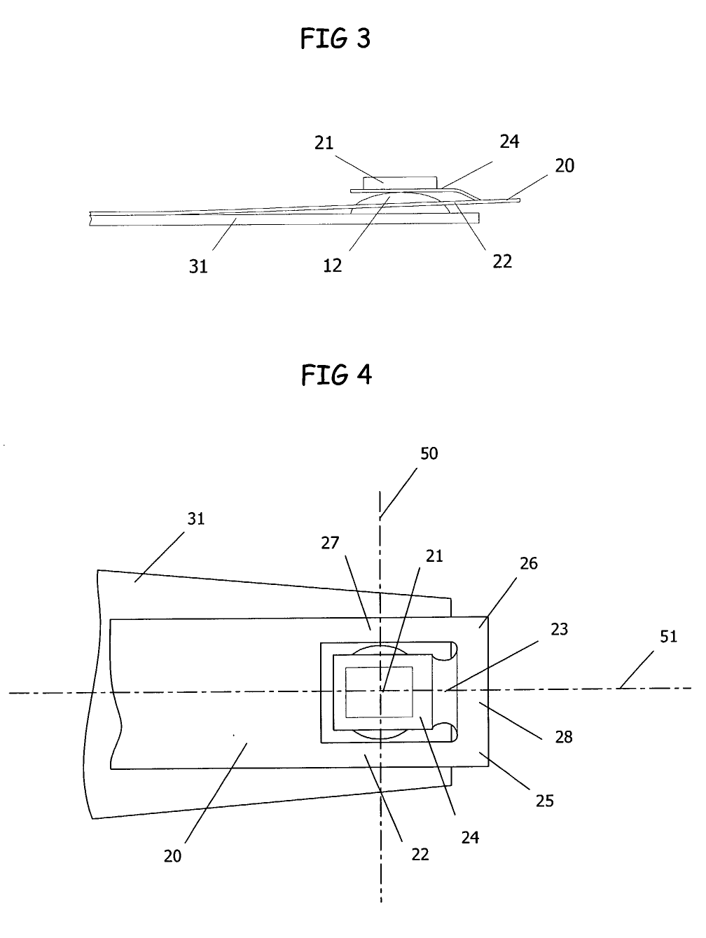

FIG. 3 is a more detailed side view of the gimbal assembly according to an embodiment of the present invention. FIG. 4 is a simplified top view of the gimbal assembly according to an embodiment of the present invention. These diagrams are merely examples, which should not unduly limit the scope of the claims herein. One of ordinary skill in the art would recognize many other variations, modifications, and alternatives. As shown, FIGS. 3 and 4 give a detailed side and top view of the load beam distal end. This region is composed of a load beam gimbal mounting region 31, a dimple 12, a gimbal 20 and an air bearing slider 21. The gimbal 20 is mounted at the distal end of the load beam and support the slider 21. The slider 21 is in contact with the dimple 12 which allow pitch and roll movement. The pitch movement is defined as the rotation about the axis 50. The roll movement is defined as the rotation about the axis 51. The gimbal is formed of different region: the tongue 24, the hinge 23, the outriggers 25 and 26, the tip 28 and the beams or arms 22 and 27. Specific details for manufacturing the assembly are provided throughout the present specification and more particularly below.

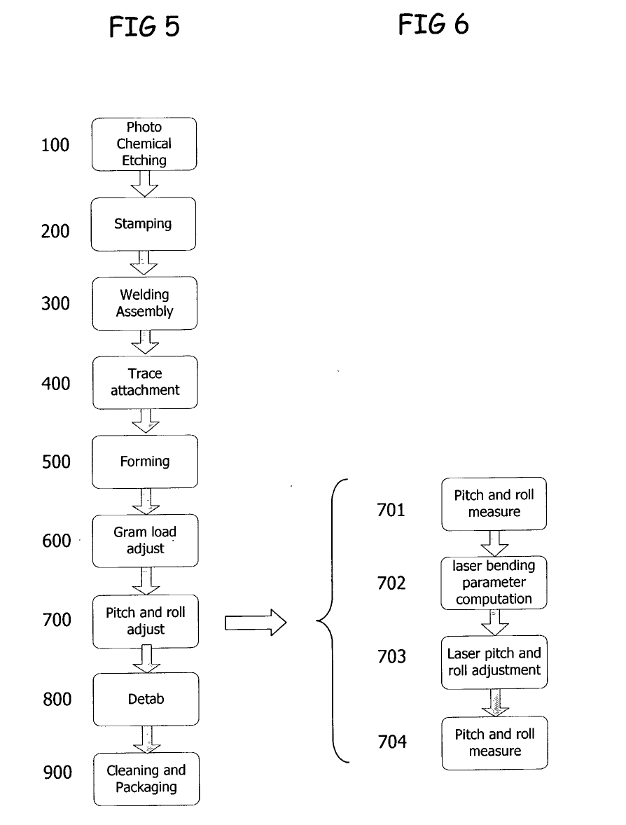

FIG. 5 shows a flow diagram of the suspension manufacturing. This diagram is merely an example, which should not unduly limit the scope of the claims herein. One of ordinary skill in the art would recognize many alternatives, modifications, and variations. From a thin sheet of stainless steel the general shapes of the suspension are etched by photochemical etching 100. Then different stamping operations 200 are carried out (e.g., reinforcement shapes, dimple and load/unload tab formation). Next is the welding assembly of the base plate, load beam and gimbal 300. To enable the reading and writing function of the head, a flexible polyamide and copper electric circuit (trace) is attached to the head 400. At this stage the suspension is given an initial pre load by rolling or coining forming 500. Once pre formed, the suspension gram load is fine adjusted 600. The step 700 corresponds to the laser pitch and roll adjustment. At last the suspension are separated 800, cleaned and packed 900.

FIG. 6 gives a detailed flow diagram of the pitch and roll laser adjustment with its four stations. This diagram is merely an example, which should not unduly limit the scope of the claims herein. One of ordinary skill in the art would recognize many alternatives, modifications, and variations. After gram load adjustment the suspension pitch and roll angle are measured on the station 701. From these values, an algorithm determine the different parameter needed for the laser adjustment (702). Among these parameters are: laser energy, laser spot location, scanning length for scanning adjustment, scanning speed, irradiation time for spot adjustment, pulse frequency, spot size, pitch for multiple scanning, etc. The suspension to be adjusted is presented to the adjustment station 703. A laser beam is applied at the pre-defined location(s) in order to bring the pitch and roll close to target. Once adjusted to its nominal pitch and roll angle, the suspension is fed to the last measurement station 704 which valid or reject the adjustment.

Laser bending has become an important process for accurate non-contact shaping of metallic component, it offer certain advantages of a high flexibility allowing different bending configuration without the requirement of a specific tooling for every application. In an industry where the product design constantly evolves, this is an advantage.

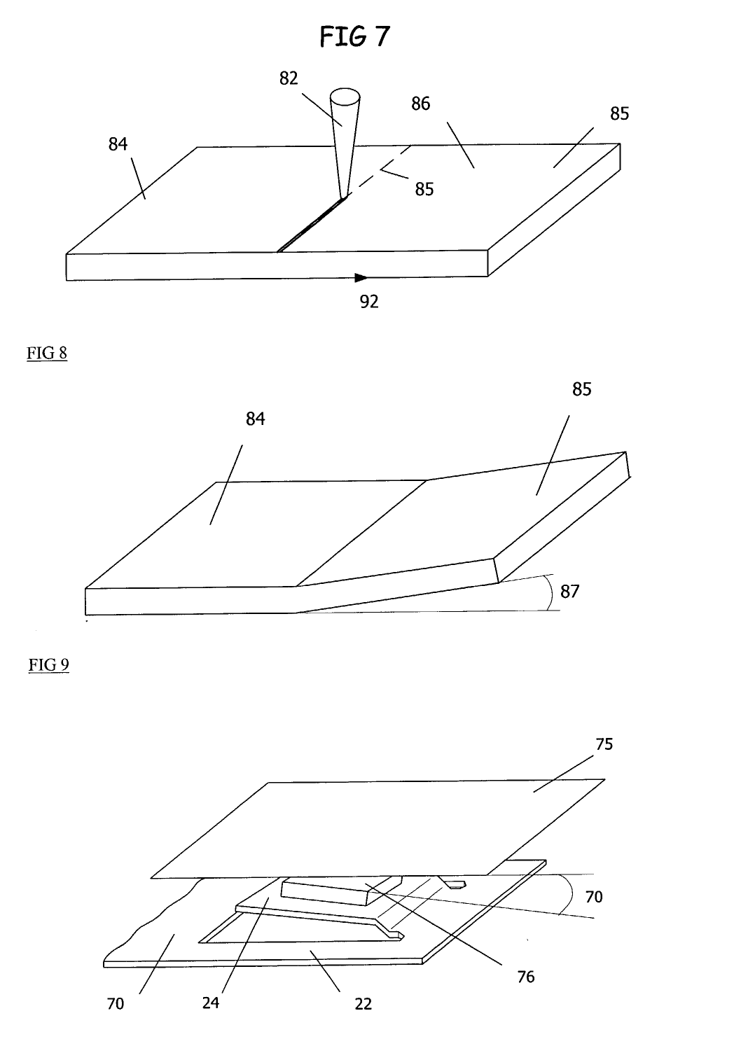

FIGS. 7, 8, and 9 illustrate the principle of laser bending. These diagrams are merely examples, which should not unduly limit the scope of the claims herein. One of ordinary skill in the art would recognize many other variations, modifications, and alternatives. An originally flat sheet of metal 86 is clamped on its proximal end 84 and in free state on its distal end 85. The sheet 86 is subjected to a laser beam 82 moving along the scanning path 85. After irradiation and cooling the sheet is bend along the path 85 as shown on FIG. 8. The main mechanism of laser bending is the temperature gradient mechanism. The laser irradiation creates a transient temperature field across the sheet thickness, which result in a differential expansion through the thickness. During the heating phase, a zone of thermal expansion 83 appears resulting in bending the sheet in the direction away from the laser (counter bending). When cooling, the material contracts in the upper layer 88 and the sheet bend in a definitive manner in the direction of the laser. Depending on the bending angle desired, several parameters such as beam diameter, scanning velocity, laser power, scanning length have to be determined.

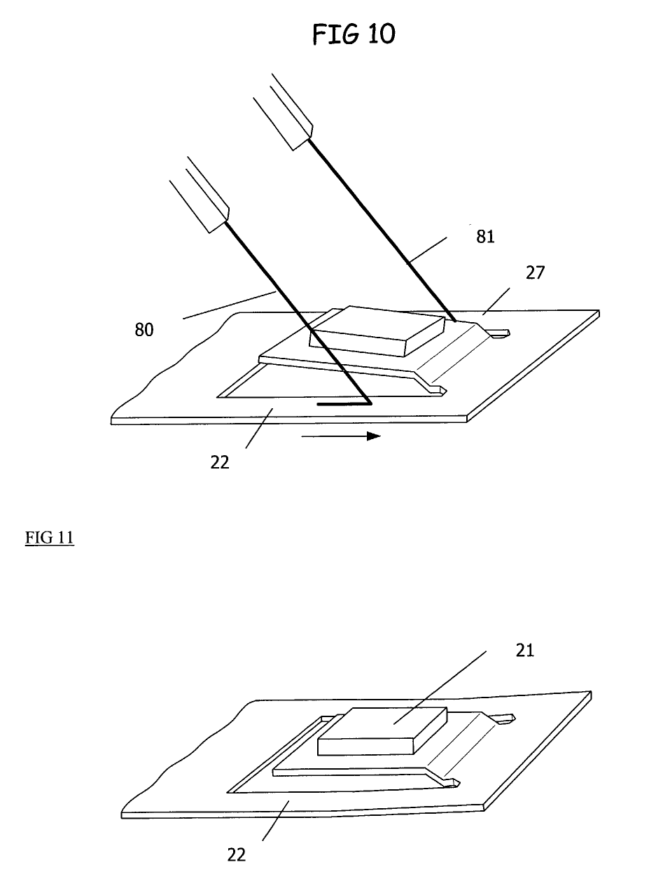

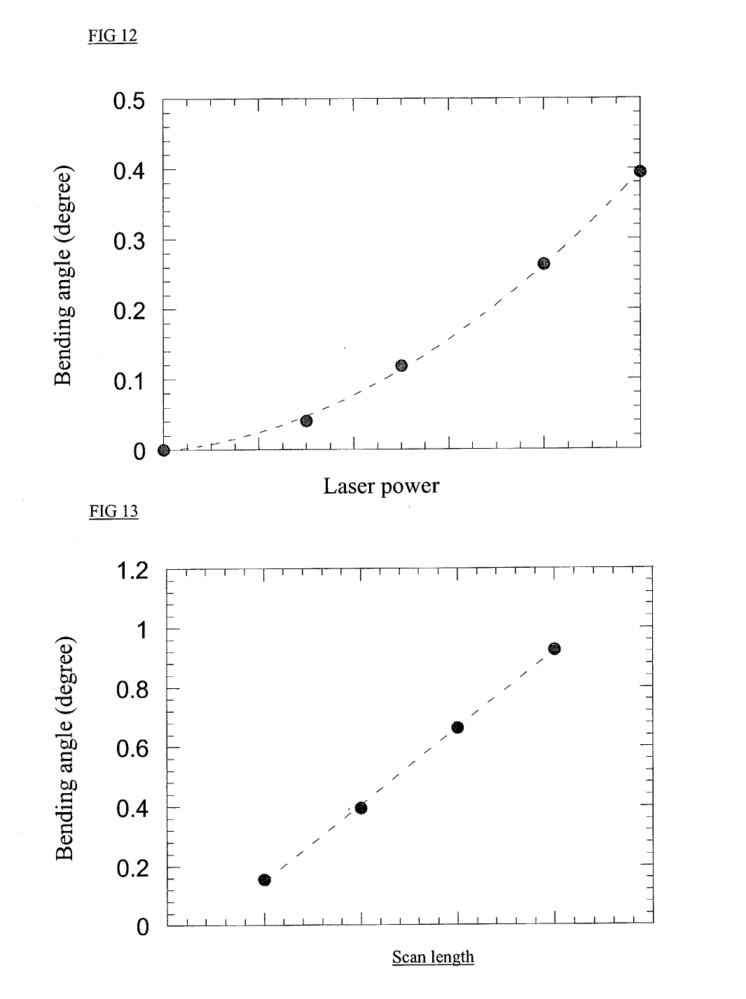

FIGS. 9, 10, and 11 illustrate an example of suspension static adjustment applying the disclosed invention. These diagrams are merely examples, which should not unduly limit the scope of the claims herein. One of ordinary skill in the art would recognize many other variations, modifications, and alternatives. The pitch angle 70 - angle between the slider top side 76 and a plan parallel to the storage medium 75 - is measured at the measurement station 701. From this value several parameters of the laser bending are determined: laser energy, laser spot location, scanning length for scanning adjustment, scanning speed, irradiation time for spot adjustment, pulse frequency, spot size, pitch for multiple scanning, etc. (702). Example of relation between these parameters and the bending angle obtained are show on FIGS. 13 and 14. Using the calculated parameter the pitch angle of the suspension is adjusted by irradiating the gimbal beams 22 and 27 with the laser beam 80 and 81 respectively. As described earlier this heating will result in a transient temperature field across the thickness of the gimbal beam 22 and 27. After cooling the gimbal beam 22 and 27 deform toward the heating source. This bending result in a rotation of the gimbal tongue 24 and consequently in an adjustment of the slider static attitude.

Depending of the area irradiated (beam, hinge, tip, outrigger) this method allows to adjust either or both parameter of the static attitude (pitch and roll angle) simultaneously.

One of ordinary skill in the art would recognize many other variations, modifications, and alternatives. The above example is merely an illustration, which should not unduly limit the scope of the claims herein. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for manufacturing a gimbal assembly for a disk drive apparatus, the method comprising:
irradiating a desired portion of a suspension material;
maintaining other portions of the suspension material free from irradiation; and
causing a bend to a predetermined angle in the suspension material in a vicinity of the desired portion of the suspension material based upon the irradiating of the desired portion.

2. The method of claim 1 wherein the irradiating is provided by a laser source.

3. The method of claim 1 wherein the irradiating is provided by a heat source.

4. The method of claim 1 wherein the bend allows for a static attitude adjustment.

5. A method for adjusting pitch and roll static attitude of suspension and/or head gimbal assembly, the method comprising:
simultaneously measuring a pitch and roll static attitude of suspension or head gimbal assemblies;
calculating or determining the laser energy required on either or both sides of the outrigger to cause a desired adjustment of both pitch and roll static attitude simultaneously; and
irradiating a single spot of continuous wave or pulsed laser on a well-defined location on either or both sides of the gimbal beam, outrigger, tip or tongue while suspension or head gimbal assemblies are in free-state.

6. The method in claim 5 wherein the pitch and roll static attitude adjustment is performed by irradiating continuous wave or pulsed laser on multiple locations on either or both sides of the gimbal while suspension or head gimbal assemblies are in free-state.

7. The method in claim 5 wherein the pitch and roll static attitude adjustment is performed by line scanning of pulsed laser along either or both sides of the outrigger and/or gimbal area while suspension or head gimbal assemblies are in free-state.

8. The method in claim 5 wherein the pitch and roll static attitude adjustment is performed by line scanning of pulsed laser along either or both sides of the outrigger and/or gimbal area while suspension or head gimbal assemblies are in free-state.

9. The method in claim 5 wherein the parameter used for varying the adjustment are: Laser energy, pulse frequency, scanning length, scanning pitch when multiple scanning, scanning speed, Spot size location or any other laser parameters.
